(19) United States
(12) Patent Application Publication
(10) Pub. No.: US 2002/0030600 A1
(43) Pub. Date: Mar. 14, 2002

(54) Fire alarm beacon system

(76) Inventors: Thad E. Starner, Atlanta, GA (US); Daniel Ashbrook, Atlanta, GA (US)

Correspondence Address: Tiffany de Lisio, 1734 P ST., NW #4, Washington, DC, 20036, US

(21) Appl. No.: 09/915,372

(22) Filed: Jul. 27, 2001

Related U.S. Application Data
(60) Provisional application No. 60/221,106, filed on Jul. 27, 2000.

(51) Int. Cl. G08B 17/10

(52) U.S. Cl. 340/628; 340/540

(57) ABSTRACT

A combination smoke detector, fire alarm, emergency light, location beacon and inventory sensor incorporated into pre-installed smoke alarms which are already required by building code to be registered on building floor plans, can be powered internally or externally and part of a central system or individual systems responding to local transmissions and thus eliminating the additional expense and need to install and/or possibly maintain addition devices and exploiting advantageously a preexisting logical system of coordinates from which to monitor the loci of rescuer workers and even key security and cleaning staff, if necessary, as well as inventory in hospitals and warehouses.

This application claims the benefit of U.S. Provisional Application No. 60/221,106, filed Jul. 27, 2000.

### FIELD OF THE INVENTION

The present invention relates generally to fire alarms and, more specifically, to a device which incorporates a fire alarm and a location system.

### BACKGROUND OF THE INVENTION

Today, smoke detectors are commonly found in most homes. Local building codes and insurance companies often require that smoke detectors be installed in newly constructed buildings and in commercial buildings. Moreover, public awareness of the benefits of smoke detectors and their relatively low cost have made them universally popular. Most commercial buildings such as hospitals and warehouses have smoke detectors in each room or area and several along hallways. Additionally, many commercial structures have fire alarms in every room linked to a central system that, when fire is detected, causes the fire alarms to produce loud sirens and flashing lights. U.S. Pat. No. 5,821,866 by Bernal et. al, U.S. Pat. No. 5,444,434 by Serby, and U.S. Pat. No. 5,640,058 by Calvo describe various types of DC and AC powered smoke detectors of this type.

The art shows many examples of improved fire detectors and alarms. Some are self-diagnosing to insure proper operation. Others have backup batteries, extended battery life, or communicate with other units or a central computer.

There are also several examples of combination fire alarms or smoke detectors. In U.S. Pat. No. 5,731,759, Finucan describes a combination smoke detector, alarm, and flashlight. In U.S. Pat. No. 4,949,077, Mbuthia describes a combination smoke alarm, clock radio, compass, retractable table and lamp. Brown describes in U.S. Pat. No. 4,617,561 a combination smoke detector and emergency light system.

None of the combinations relating to smoke detectors or fire alarms found in the art, however, describe improvements to enhance the safety of rescue workers, or to provide much more utility than simple fire detection.

Also described in the art are various types of beacon location systems. In U.S. Pat. No. 4,209,787 to Freeny, a method for monitoring the location of monitored objects is described. U.S. Pat. No. 5,218,367 to Sheffer et al. describes a vehicle tracking system that uses signal strength to determine proximity. There are several downsides apparent to these stand-alone beacons, however. Since they all require electrical power to operate, new wiring would have to be put in place all over a building to attach them to. If run off of battery power, the batteries would have to be changed at frequent intervals.

There are existing patents which relate to time and location based computing, such as U.S. Pat. No. 5,642,303 to Small et al., however, it fails to contemplate the dual use of the smoke detector as sensor and firefighter locator and or inventory tracking, therefore the relevant field remains open for development.

More complex locating systems exist, such as the independent interior GPS navigation system issued in U.S. Pat. No. 5,959,575 to Abbott, which includes “a) disposing a plurality of ground transceivers in proximity of an indoor area to be navigated through; (b) transmitting from each of the ground transceivers a pseudo-satellite signal” which includes positional coordinates of the ground transceiver with assigned codes sequence modulated on an L-band carrier signal having a frequency ultimately enabling the system to derive the location coordinates of the mobile GPS receive, but is so complex and comprehensive that the average consumer or business would have neither the need nor the inclination to install and utilize it for simple mobile location tracking and/or inventory control purposes, whereas the utilization of devices which are already mandatory in most buildings and have their own power sources can easily be modified to serve or achieve the same purpose at a fraction of the cost.

U.S. Pat. No. 5,977,913 to Christ features a system, less complex than the GPS system and has been utilized to track individuals within buildings by incorporating strategically placed sensors that are coupled with a central computer via AC power lines. This is an independent tracking system, however, which does not contemplate the combined applications as conceptualized by the present invention, which utilizes a preinstalled smoke and fire detectors as the modules for tracking the coordinates of mobile sensors and communication devices or transmitters which are capable of receiving and relaying signals to and from compatible devices imbedded in firemen's suits or worn on staff person's clothing which would convey pertinent location information to the authorized party concerned about the whereabouts of pertinent individuals in the event of a crises or other tracking activity.

While smoke detectors and fire alarms do much to increase the safety of those living or working in a building, they do little assist firefighters or other rescue workers that may need to enter the building during a fire to extinguish the blaze or save those trapped inside. Smoke and ashes may obscure the sight of the rescue worker, making it difficult to maintain a clear sense of location. A beacon system attached to a central communications system that allowed the rescue workers to know their location at all times would be an ideal solution; however, installation and maintenance of this type of system has the potential to be very difficult. Configuration and use of such a system also has potential pitfalls; when a receiving unit “hears” a beacon, it knows its location relative to the beacon, but for that information to be useful to a user, a floor plan must be encoded so that the user knows where the beacon is.

The above-cited prior art is not intended to be exhaustive, but is, on the other hand, illustrative of the scope of prior art.

### SUMMARY OF THE INVENTION

The present invention overcomes the limitations of the inventions disclosed in the prior art. By integrating a location beacon with such common (and in many cases, required by law) devices such as independently-powered smoke detectors or fire alarms, installation, maintenance, configuration and use of such a system becomes much easier. An integrated unit can be “dropped in” in place of old units and run off of the same power as the old. If backup batteries are used, there are fewer batteries to check on a regular basis than would be present with a separated system. Since the location of fire alarms are often marked on a building's blueprints, configuration and use become much easier.

Another advantage to the present invention is that safety devices are likely to be adopted on a widespread scale. This amplifies the useful qualities of a combination such as a beacon system by allowing other applications to be developed.

An object of the present invention is to increase safety for rescue workers during an emergency situation by providing them with knowledge of their position in the building or structure in which they are engaged in their work.

It is also an object of the present invention to allow this capability to be used in other capacities, such as theft prevention of expensive equipment; expedient location of security and/or cleaning staff wearing a sensor that can interface with the beacon; handheld or worn direction-giving devices; inventory tracking; or automated equipment direction.

A third object of the present invention is to reduce necessary overall maintenance of fire alarms and location beacons as much as possible.

The present invention meets these objects by providing, in combination, a smoke detector and/or alarm indicator and a location beacon system. This combination allows a “drop-in” solution for buildings where a comprehensive smoke detector/fire alarm system is already in place. This new combined facet not only provides for easier installation, but makes configuration of the system very simple since the locations of fire alarms are usually noted on floor plans of commercial buildings. This also allows rescue workers to know the exact location of the beacons simply by looking at the floor plan, thereby reducing preparation time before entering the building and possibly saving lives. The combination also reduces maintenance costs because both the smoke detector and location beacon can be powered off of the same power source, which can be AC from the building's power source and/or DC from an internal battery (typically a 9v cell), and there are therefore no additional units to inspect or replace.

### BRIEF DESCRIPTION OF THE DRAWINGS

FIG. 1 is an electrical block diagram, schematically showing components and connections with the device.

### DETAILED DESCRIPTION OF THE PREFERRED EMBODIMENTS

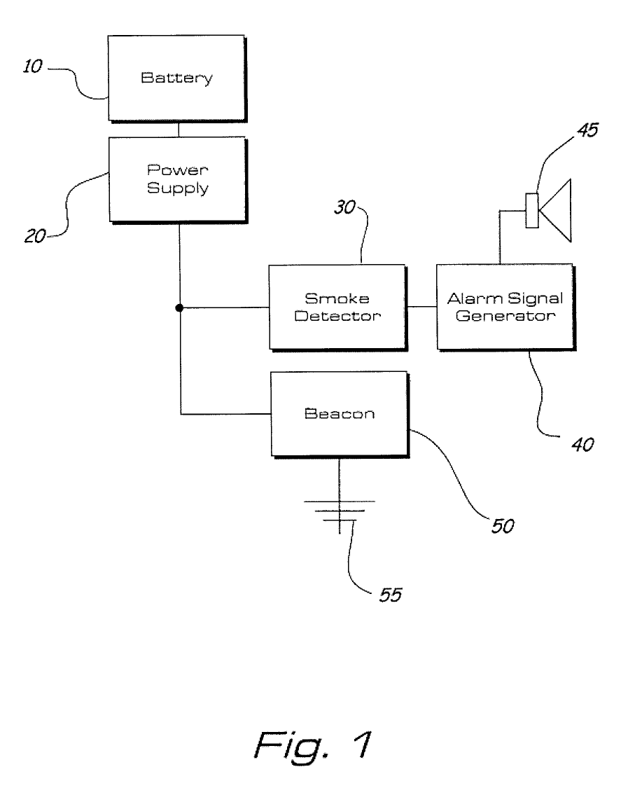

FIG. 1 shows an electrical block diagram of the present invention. In FIG. 1, a backup battery 10 is wired in conjunction with a power supply 20, which may be a primary battery or outside power source such as AC power. Power supply 20 is connected to a conventional smoke detector 30, which is connected to an alarm signal generator 40. The alarm signal generator 40 has a loudspeaker 45 connected to it. When smoke or other products of combustion are detected at 30, the alarm signal generator 40 produces an output signal that drives loudspeaker 45 causing it to produce a loud, continuous sound.

Power supply 20 is also connected to a beacon 50 which has an optional antenna 55. Beacon 50, using antenna 55 if necessary, emits a periodic, pre-determined signal that is unique to said beacon.

Once the unit has been installed, it will emit a periodic beacon that may be picked up by a mobile sensor or receiver locally externally to the unit, attuned to the type of signal the beacon is emitting. Either the unit or the mobile device may transmit evidence that a signal has been exchanged to a central operating system or other mechanism designed to receive and track the locations emitting by the signals.

Another embodiment of the present invention is a combination of a combustion detector and a location beacon. The location beacon may communicate via signals transmitted in the radio spectrum, via sound waves including audible and ultrasonic, or via visible or invisible light, including that produced by a laser or a light emitting diode. The combustion detector may have the ability to detect smoke and/or fire. The combustion detector and location beacon may be powered by direct or alternating current. The power source may be located internally or external to the combination.

Another embodiment of the present invention is a combination of an alarm and a location beacon. The location beacon may communicate via signals transmitted in the radio spectrum, via signals emanating from a wireless transceiver mechanism, via sound waves including audible and ultrasonic, or via visible or invisible light, including that produced by a laser or a light emitting diode. The alarm may be activated by an external signal, which may be transmitted by electrical means, including a signal transmitted via a wire or cable. The wire or cable may provide alternating or direct current to the combination in addition to transmitting a signal. The alarm may produce an audible or visible alert, or both.

The alarm and location beacon may be powered by direct or alternating current. The power source may be located internally or external to the combination.

The above combinations may substitute an emergency light in place of the combustion detector or alarm. Furthermore, the combination can easily be adopted to serve as a wall mounted inventory control device in hospitals, stores and warehouses. The resultant combination has all applicable characteristics and capabilities of the above embodiments.

Numerous manifestations of the proffered description of the preferred embodiments of this invention can be envisioned by those skilled in the art; therefore the following disclosures should not be construed as limitations of the invention.

What is claimed is:

1. A combination of a combustion detector and a location beacon.

2. The combination as recited in claim 1 wherein said location beacon contains invisible communication means.

3. The beacon as recited in claim 1 wherein said invisible communication means is transmitted in the radio spectrum.

4. The beacon as recited in claim 1 wherein said invisible communication means is transmitted by sound waves.

5. The beacon as recited in claim 1 wherein said sound waves are audible and or amplified by means of an electronic sound card incorporated into the transceiving mechanism.

6. The beacon as recited in claim 4 wherein said sound waves are ultrasonic.

7. The beacon as recited in claim 1 wherein said invisible communication means is transmitted in the light spectrum.

8. The beacon as recited in claim 1 wherein said invisible communication means is produced by a laser.

9. The beacon as recited in claim 1 wherein said invisible communication means is produced by a light emitting diode.

10. The combination as recited in claim 1 wherein said location beacon contains visible communication means.

11. The location beacon as recited in claim 10 wherein said visible communication means is produced by a laser.

12. The location beacon as recited in claim 10 wherein said visible means is produced by a light emitting diode.

13. The combination as recited in claim 1 wherein said combustion detector possesses smoke detection means.

14. The combination as recited in claim 1 wherein said combustion detector possesses fire detection means.

15. The combination as recited in claim 1 wherein said combination is powered by alternating current power means.

16. The combination as recited in claim 1 wherein said alternating current power means is provided by an external source.

17. The combination as recited in claim 1 wherein said alternating current power means is provided by an internal source.

18. The combination as recited in claim 1 wherein said combination is powered by direct current power means.

19. The combination as recited in claim 1 wherein said direct current power means is provided by an external source.

20. The combination as recited in claim 1 wherein said direct current power means is provided by an internal source.

21. A combination of a security alarm, a fire alarm and a location beacon.

22. The combination as recited in claim 21 wherein said location beacon contains invisible communication means.

23. The beacon as recited in claim 21 wherein said invisible communication means is transmitted in the radio spectrum.

24. The beacon as recited in claim 21 wherein said invisible communication means is transmitted by sound waves.

25. The beacon as recited in claim 21 wherein said sound waves are audible.

26. The beacon as recited in claim 21 wherein said sound waves are ultrasonic.

27. The beacon as recited in claim 21 wherein said invisible communication means is transmitted in the light spectrum.

28. The beacon as recited in claim 21 wherein said invisible communication means is produced by a laser.

29. The beacon as recited in claim 21 wherein said invisible communication means is produced by a light emitting diode.

30. The combination as recited in claim 21 wherein said location beacon contains visible communication means.

31. The location beacon as recited in claim 21 wherein said visible communication means is produced by a laser.

32. The location beacon as recited in claim 21 wherein said visible means is produced by a light emitting diode.

33. The combination as recited in claim 21 wherein said combination is powered by alternating current power means.

34. The combination as recited in claim 21 wherein said alternating current power means is provided by an external source.

35. The combination as recited in claim 21 wherein said alternating current power means is provided by an internal source.

36. The combination as recited in claim 21 wherein said combination is powered by direct current power means.

37. The combination as recited in claim 21 wherein said direct current power means is provided by an external source.

38. The combination as recited in claim 21 wherein said direct current power means is provided by an internal source.

39. The combination as recited in claim 21 wherein said alarm is activated by receipt of an external signal.

40. The combination as recited in claim 21 wherein said external signal is transmitted by wireless electrical means.

41. The combination as recited in claim 21 wherein said electrical means is a signal transmitted over a wire.

42. The combination as recited in claim 21 wherein said wire provides AC power to said combination in addition to said signal.

43. The combination as recited in claim 21 wherein said wire provides DC power to said combination in addition to said signal.

44. The combination as recited in claim 21 wherein said alarm produces an audible alert.

45. The combination as recited in claim 21 wherein said alarm produces a visual alert.

46. A combination of an emergency light, fire alarm and a location beacon.

47. The combination as recited in claim 46 wherein said location beacon contains invisible communication means.

48. The beacon as recited in claim 46 wherein said invisible communication means is transmitted in the radio spectrum.

49. The beacon as recited in claim 46 wherein said invisible communication means is transmitted by sound waves.

50. The beacon as recited in claim 46 wherein said sound waves are audible.

51. The beacon as recited in claim 46 wherein said sound waves are ultrasonic.

52. The beacon as recited in claim 46 wherein said invisible communication means is transmitted in the light spectrum.

53. The beacon as recited in claim 46 wherein said invisible communication means is produced by a laser.

54. The beacon as recited in claim 46 wherein said invisible communication means is produced by a light emitting diode.

55. The combination as recited in claim 46 wherein said location beacon contains visible communication means.

56. The location beacon as recited in claim 46 wherein said visible means is produced by a laser.

57. The location beacon as recited in claim 46 wherein said visible means is produced by a light emitting diode.

58. The combination as recited in claim 46 wherein said combination is powered by alternating current power means.

59. The combination as recited in claim 46 wherein said alternating current power means is provided by an external source.

60. The combination as recited in claim 46 wherein said alternating current power means is provided by an internal source.

61. The combination as recited in claim 46 wherein said combination is powered by direct current power means.

62. The combination as recited in claim 46 wherein said direct current power means is provided by an external source.

63. The combination as recited in claim 46 wherein said direct current power means is provided by an internal source.
